(19) United States
(12) Patent Application Publication
(10) Pub. No.: US 2009/0079228 A1
(43) Pub. Date: Mar. 26, 2009

(54) HEIGHT ADJUSTABLE ARMREST ASSEMBLY

(75) Inventors: Alan Sturt, West Bloomfield, MI (US); Mark Heinze, Clarkston, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 11/860,862

(22) Filed: Sep. 25, 2007

(51) Int. Cl. B60N 2/46; B60J 9/00

(52) U.S. Cl. 296/153; 296/1.09

(57) ABSTRACT

A height adjustable armrest assembly for use with a vehicle may include a support member adapted for connection to a vehicle body. A linkage may be supported by the support member and an armrest member may be supported by the linkage. The linkage may be configured to move the armrest member between a lowered position and a raised position such that the angular orientation between the support member and the armrest member when the armrest member is in the raised position is substantially the same as when the armrest member is in the lowered position.

### BACKGROUND OF THE INVENTION

1. Field of the Invention

The field of this invention relates to height adjustable armrests for use in vehicles.

2. Background Art

A height adjustable armrest assembly is disclosed herein. Examples of armrest assemblies are disclosed in U.S. Pat. Nos. 7,163,248; 6,905,163; 6,796,601; 5,823,624; and 4,311,338 and in U.S. Patent Application Publication No. 2007/0080560.

### SUMMARY OF THE INVENTION

Under the invention, a height adjustable armrest assembly for use in a vehicle is provided. In a first embodiment, the assembly includes a support member that may be adapted for connection to a vehicle body. A linkage is supported by the support member and an armrest is supported by the linkage. The linkage is configured to move the armrest member between a lowered position and a raised position such that the angular orientation between the support member and the armrest member when the armrest member is in the raised position is substantially the same as when the armrest member is in the lowered position.

In at least one implementation of the first embodiment, the linkage may comprise a plurality of bars. In at least one variation of this implementation, each bar may be substantially parallel to each of the other bars and each bar may remain substantially parallel to each of the other bars as the armrest member moves between the raised position and the lowered position. In at least another variation of this implementation, the armrest member and the plurality of bars define a four bar mechanism.

In at least another implementation of the first embodiment, the linkage may include a lockable hinge. The lockable hinge may be configured to inhibit movement of the armrest member from the raised position towards the lowered position when the hinge is locked. The lockable hinge may permit movement of the armrest member from the raised position towards the lowered position when the hinge is unlocked. In at least one variation of this implementation, the lockable hinge may comprise a wrap spring clutch. In another variation of this implementation, the linkage may further include a second lockable hinge. The second lockable hinge may be configured to inhibit movement of the armrest member from the raised position towards the lowered position when the second lockable hinge is locked. The second lockable hinge may permit movement of the armrest member from the raised position towards the lowered position when the second lockable hinge is unlocked. In another variation, the linkage may be configured to maintain a substantially constant angular orientation of the armrest member as the armrest member moves between the lowered position and the raised position. The lockable hinge and the linkage may also cooperate to support the armrest member at a plurality of user selected height positions disposed between the raised position and the lowered position.

In at least another implementation of the first embodiment, the assembly may further include a motion damper connected to the linkage. The motion damper may be configured to slow the movement of the armrest member from the raised position towards the lowered position.

In at least a second embodiment, the assembly includes a support member that is adapted for connection to a vehicle body. A first bar is pivotably connected to the support member. A second bar is also be pivotably connected to the support member at a position that is spaced apart from the first bar. An armrest member is supported by the first bar and the second bar. The first bar and the second bar cooperate to maintain a substantially constant angular orientation of the armrest member with respect to the support member as the armrest member is raised and lowered.

In at least one implementation of the second embodiment, the assembly may further include a lockable hinge. The lockable hinge may connect one of the first and the second bars to one of the armrest member and the support member. The lockable hinge may be configured to inhibit pivoting in a first direction when locked and to permit pivoting in the first direction when released. In at least one variation, the assembly may further include a release member for selectively unlocking the hinge member. In another variation, the armrest member may be wider than the hinge member when measured in a direction that is perpendicular to a longitudinal axis of the armrest member. In another variation, the lockable hinge may be a first hinge. The assembly may further include a second lockable hinge connecting the other of the first and the second bars to one of the armrest member and the support member. The second lockable hinge may be configured to inhibit pivoting in the first direction when locked and to permit pivoting in the first direction when released. In another variation, the lockable hinge may be a wrap spring clutch.

In at least another implementation of the second embodiment, the assembly may further include a motion damper that is connected to one of the first bar and the second bar to slow the armrest member as the armrest member moves from the raised position towards the lowered position.

In at least a third embodiment, the assembly includes a support member adapted for connection to a vehicle body. A bin is disposed below the support member. A linkage is supported by the support member. An armrest member is supported by the linkage and is configured to selectively cover and uncover the bin. The linkage is configured to move the armrest member between a lowered position and a raised position such that the angular orientation between the support member and the armrest member when the armrest member is in the raised position is substantially the same as when the armrest member is in the lowered position.

In at least one implementation of the third embodiment, the linkage may comprise a plurality of bars. Each bar may be substantially parallel to each of the other bars. Each bar may remain substantially parallel to each of the other bars as the armrest member moves between the raised position and the lowered position. In at least one variation of this implementation, the linkage may include a lockable hinge that may be configured to inhibit movement of the armrest member from the raised position towards the lowered position when locked and to permit movement of the armrest member from the raised position towards the lowered position when unlocked. In a further variation of this implementation, the assembly may further include a motion damper. The motion damper may be connected to the linkage. The motion damper may be configured to slow the movement of the armrest member from the raised position towards the lowered position.

### BRIEF DESCRIPTION OF THE DRAWINGS

FIG. 1A is a perspective view illustrating an embodiment of a height adjustable armrest assembly made in accordance with the teachings of the present invention with an armrest member in a lowered position;

FIG. 1B is a perspective view illustrating the armrest assembly of FIG. 1A with the armrest member in a raised position;

FIG. 1C is a perspective view illustrating the armrest assembly of FIG. 1A showing the armrest member rotated upwards to provide a vehicle occupant with access to a bin;

FIG. 2 is a fragmentary side elevational view of the height adjustable armrest assembly depicted in FIG. 1A;

FIG. 3 is a fragmentary side elevational view of the height adjustable armrest assembly of FIG. 1B;

FIG. 4 is a fragmentary side elevational view illustrating the height adjustable armrest assembly of FIG. 3 as it moves from the raised position towards the lowered position;

FIG. 5 is a cross-sectional view of the armrest assembly of FIG. 1B taken along the line 5-5 in FIG. 1B;

FIG. 6 is a fragmentary side elevational view of a second embodiment of a height adjustable armrest assembly;

FIG. 7 is a fragmentary side elevational view of a third embodiment of a height adjustable armrest assembly; and

FIG. 8 is a fragmentary side elevational view of a fourth embodiment of a height adjustable armrest assembly.

### DETAILED DESCRIPTION OF THE ILLUSTRATED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

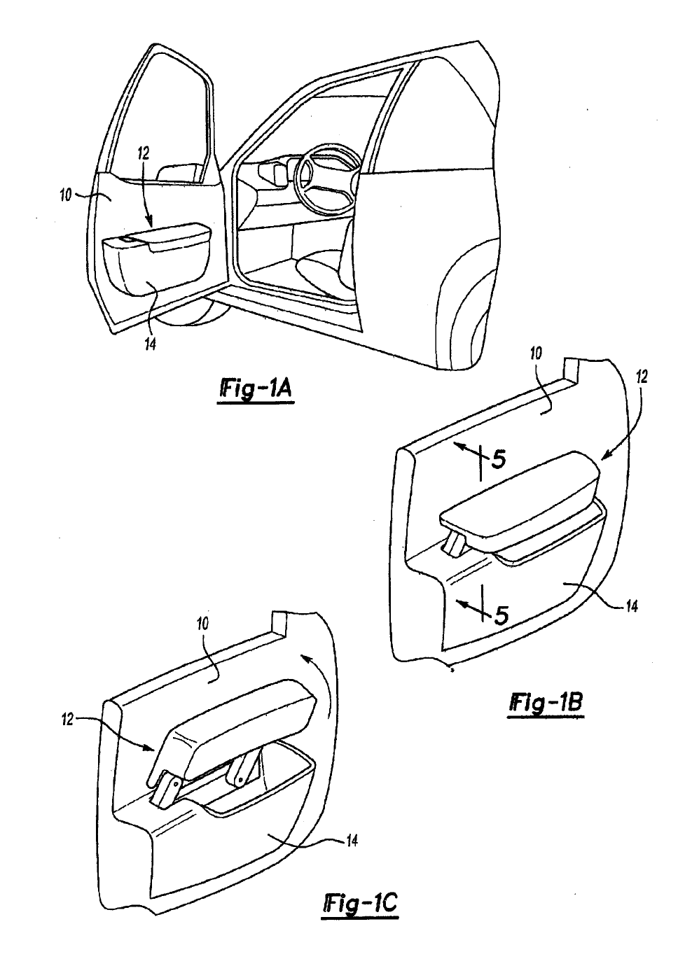

FIGS. 1A-1C illustrate an embodiment of a height adjustable armrest assembly of the present invention in three different conditions, raised, lowered and open, respectively. With reference to FIG. 1A, a door panel assembly 10 is equipped with the height adjustable armrest assembly 12. While door panel assembly 10 is illustrated as an interior door panel for an automobile, it should be understood by those of ordinary skill in the art that the height adjustable armrest assembly 12 of the present invention is compatible with all types of vehicles including aircraft, watercraft, spacecraft, and other types of landcraft including, but not limited to, commercial and privately owned automobiles, trucks and vehicles that operate on rails. As illustrated in FIGS. 1A and 1B, the height adjustable armrest assembly 12 is configured to move between a lowered position (FIG. 1A) and a raised position (FIG. 1B). FIG. 1C illustrates an additional feature of the height adjustable armrest assembly of the present invention. The door panel assembly 10 includes a bin 14 positioned below the height adjustable armrest assembly 12. Bin 14 may be used by vehicle occupants to store personal articles. Height adjustable armrest assembly 12 serves as a lid for bin 14 and can be positioned to alternatively cover (see FIGS. 1A and 1B) or uncover (see FIG. 1C) bin 14. Height adjustable armrest assembly 12 and bin 14 can provide a vehicle occupant with increased comfort and added security.

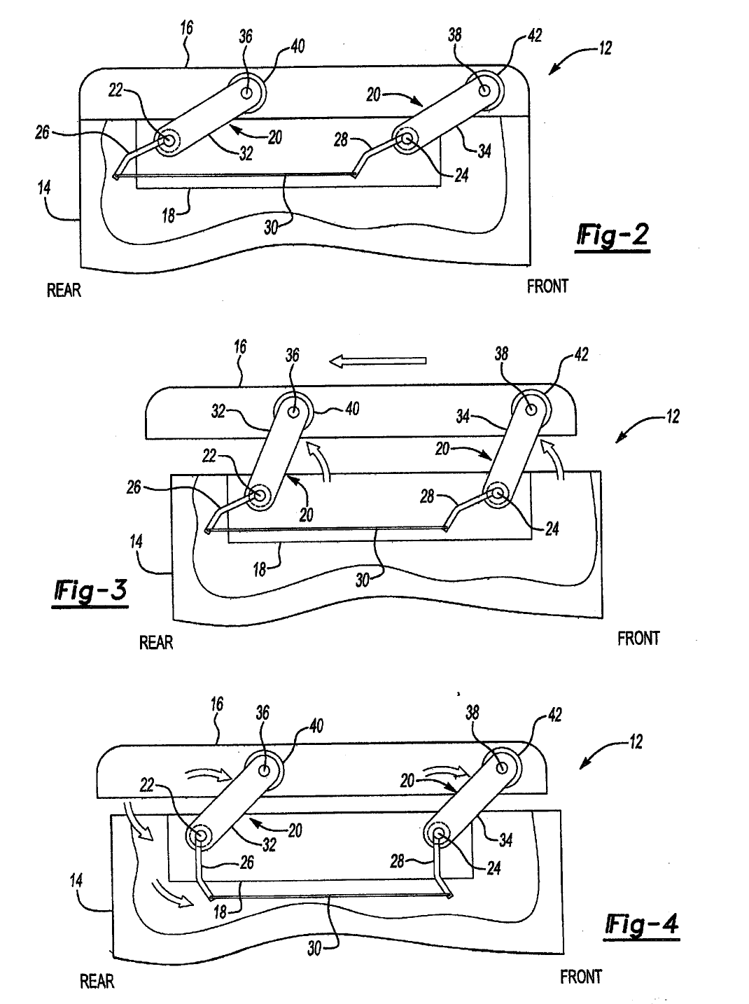

FIG. 2 is a side elevational view of height adjustable armrest assembly 12 illustrating various components of the assembly. The height adjustable armrest assembly 12 illustrated in FIG. 2 includes an armrest member 16, a support member 18, a linkage 20, a first pivotal connector 22, a second pivotal connector 24, a third pivotal connector 36, a fourth pivotal connector 38, a first release lever 26, a second release lever 28, a connecting rod 30. Armrest member 16 may include cushioning (not shown) and may be disposed on door panel assembly 10 in a location suitable for supporting an arm or other body part of a vehicle occupant.

Armrest member 16 is connected to support member 18 by linkage 20. Support member 18 may be a portion of door panel assembly 10 or, as illustrated, it may be a separate component that is attached to door panel assembly 10. Alternatively, support member 18 may be attached to other internal parts of a vehicle, including, but not limited to, an interior trim panel or a center console or any other part of the vehicle body. In the illustrated embodiment, linkage 20 includes a first bar 32 and a second bar 34. In other embodiments, other types of links may comprise linkage 20.

First bar 32 is pivotably connected to support member 18 by first pivotal connector 22 and second bar 34 is pivotally connected to support member 18 by second pivotal connector 24. First bar 32 is pivotably connected to armrest member 16 by third pivotal connector 36 and second bar 34 is connected to armrest member 16 by fourth pivotal connector 38. In this configuration, armrest member 16, support member 18, and first and second bars 32, 34 define a four bar mechanism wherein armrest member 16 may pivot with respect to support member 18 about linkage 20. In other embodiments, a greater or lesser number of bars may be used to connect armrest member 16 to support member 18.

In FIG. 2, armrest member 16 is illustrated in the lowered position. To raise armrest member 16, a vehicle occupant may push on armrest member 16 in a direction towards the rear of the vehicle. This would cause first bar 32 and second bar 34 to pivot towards the rear of the vehicle and simultaneously move armrest member 16 upwards with respect to support member 18. For ease of reference, the front and rear of the vehicle are indicated by the words “FRONT” and “REAR” in FIG. 2-4. In other embodiments, the linkage can be reversed such that pushing armrest member 16 towards the front of the vehicle raises it and pushing armrest member 16 towards the rear of the vehicle lowers it.

FIG. 3 illustrates height adjustable armrest assembly 12 in a raised position. In the illustrated embodiment, armrest member 16 maintains substantially the same angular orientation with respect to support member 18 in both the lowered (see FIG. 2) and raised (see FIG. 3) positions. In the illustrated embodiment, this is due to the first and the second bars 32,34 having substantially the same dimensions and being arranged to remain substantially parallel to one another as armrest member 16 is raised and lowered. In other embodiments, the first and second bar may have different dimensions and may be disposed in a configuration that is not substantially parallel to one another. In the illustrated embodiment, armrest member 16 is substantially horizontal. In other embodiments, armrest member 16 may be tilted forwards or backwards as desired by repositioning first and second bars 32 and 34.

In some embodiments, pivotal connectors 22, 24, 36 and 38 may have an internal angle limiter. In other embodiments, an external angle limiter such as a peg (not shown) may be positioned on support member 18, door panel assembly 10 or elsewhere in the vehicle to limit the rearward pivot of either the first or the second bar 32,34 to maintain the armrest member 16 in a raised position. The angle limiter would preclude the linkage 20 from pivoting in a rearward direction beyond a predetermined point and would, thus, support the armrest member 16 in a raised position. In the case of an external angle limiter, the external angle limiter would be positioned at least partially to the rear of either or both first and second pivotal connectors 22, 24. In this configuration, gravity could bias armrest member 16 against the peg or pegs.

In the illustrated embodiment, the first pivotal connector 22 and the second pivotal connector 24 are both lockable hinges. In the illustrated embodiment, the lockable hinges utilized with the first and the second pivotal connectors 22,24 prevent rotation of the first and the second bars 32,34 towards the front of the vehicle until the lockable hinges are released. In this configuration, a vehicle occupant could push armrest member 16 towards the rear of the vehicle and thus raise armrest member 16 to any of a plurality of desired heights. Upon adjusting armrest member 16 to a height the vehicle occupant finds comfortable, the vehicle occupant need only stop pushing armrest member 16 to the rear of the vehicle and armrest member 16 will then remain at the user selected height. Should the vehicle occupant desire a higher adjustment of armrest member 16, he or she need only push armrest member 16 further to the rear of the vehicle. The lockable hinges utilized in the illustrated embodiment may include an angle limiter to ensure that the hinge does not rotate past a point where first and second bars are substantially perpendicular with respect to support member 18. In other embodiments, a lockable hinge which prevents rotation in either direction unless unlocked may be utilized, in which case, such angle limiter may be unnecessary.

If the vehicle occupant desires to lower armrest member 16, he or she will need to release the lockable hinges. In some embodiments, only a single lockable hinge may be used. In other embodiments, a plurality of lockable hinges may be used to more securely and robustly hold armrest member 16 at the selected height. Although first and second pivotal connectors 22,24 have been illustrated the lockable hinges, one of ordinary skill in the art will appreciate that the lockable hinges may instead be located at one or both of third pivotal connector 36 and fourth pivotal connector 38. In other embodiments, the first, second third and fourth pivotal connectors 22, 24, 36, 38 may all be lockable hinges.

A vehicle occupant desiring to lower armrest member 16 need only release the lockable hinge or hinges and simultaneously push armrest member 16 towards the front of the vehicle. In the illustrated embodiment, the first and second pivotal connectors 22,24 have been equipped with first and second release levers 26,28 respectively. In the illustrated embodiment, a connecting rod 30 connects the first and second release levers 26,28 such that when either is released, the other will also be released. In embodiments having only one lockable hinge, a single release lever will be sufficient. Correspondingly, in embodiments having two or more lockable hinges, an equivalent number of release levers or mechanisms may be required. In other embodiments, a release mechanism may be triggered by pushing armrest member 16 to the limits of an angle limiter attached to a hinge or a linkage component.

In the illustrated embodiments, third and fourth pivotal connectors 36,38 include motion dampers 40,42 to slow the decent of armrest member 16 once first release lever 26 has been released. This may provide for a more controlled decent of armrest member 16. In other embodiments, such as embodiments where the first and second pivotal connectors 22,24 comprise electric actuators whose forward and rearward rotation may be controlled, motion dampers may not be needed.

FIG. 4 illustrates the downward adjustment of armrest member 16. As illustrated, first release lever 26 has been actuated. The actuation of first release lever 26 has caused connecting rod 30 to simultaneously actuate second release lever 28. With both the first and second release levers 26 and 28 actuated, the lockable hinges in the first and second hinges 22,24 are released and armrest member 16 is free to rotate towards the front of the vehicle. In other embodiments, the orientation may be reversed and the vehicle occupant may need to push armrest member 16 towards the front of the vehicle to raise it and towards the back of the vehicle to lower it.

In some embodiments, the lockable hinge may comprise a one way locking device such as a ratchet, a wrap spring clutch or other mechanism. Wrap spring clutches permit rotation in one direction and preclude rotation in the opposite direction until released. Wrap spring clutches are known in the art and are discussed in issued U.S. Pat. No. 6,635,813 which is hereby incorporated by reference in its entirety. Wrap spring clutches are offered for sale by Reell Precision Manufacturing and information concerning wrap spring clutches may be found on its website at http://www.reell.com.

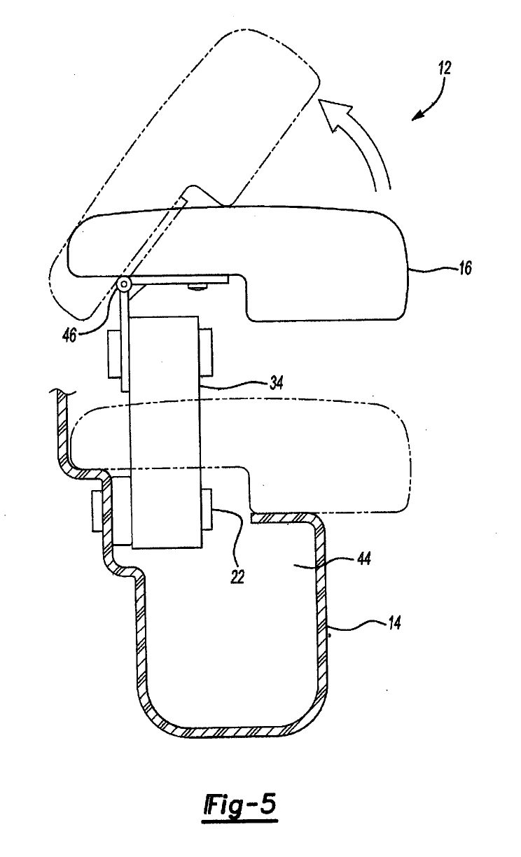

FIG. 5 illustrates the cross-sectional view taken across the line 5-5 of FIG. 1B. In this view, the storage compartment 44 inside of bin 14 is visible. Height adjustable armrest assembly 12 is illustrated in a raised position. Armrest member 16 is also illustrated in phantom lines in a lowered position to illustrate its use as a lid for bin 14. A bin hinge 46 permits armrest member 16 to pivot between a closed position and an opened position (shown open in phantom lines). When armrest member 16 is in the open position, it gives a vehicle occupant access to bin compartment 44. As illustrated, pivotal connector 22 is narrower than armrest member 16. This may afford manufacturers greater freedom in designing and/or locating the height adjustable armrest assembly 12 on a vehicle's door panel.

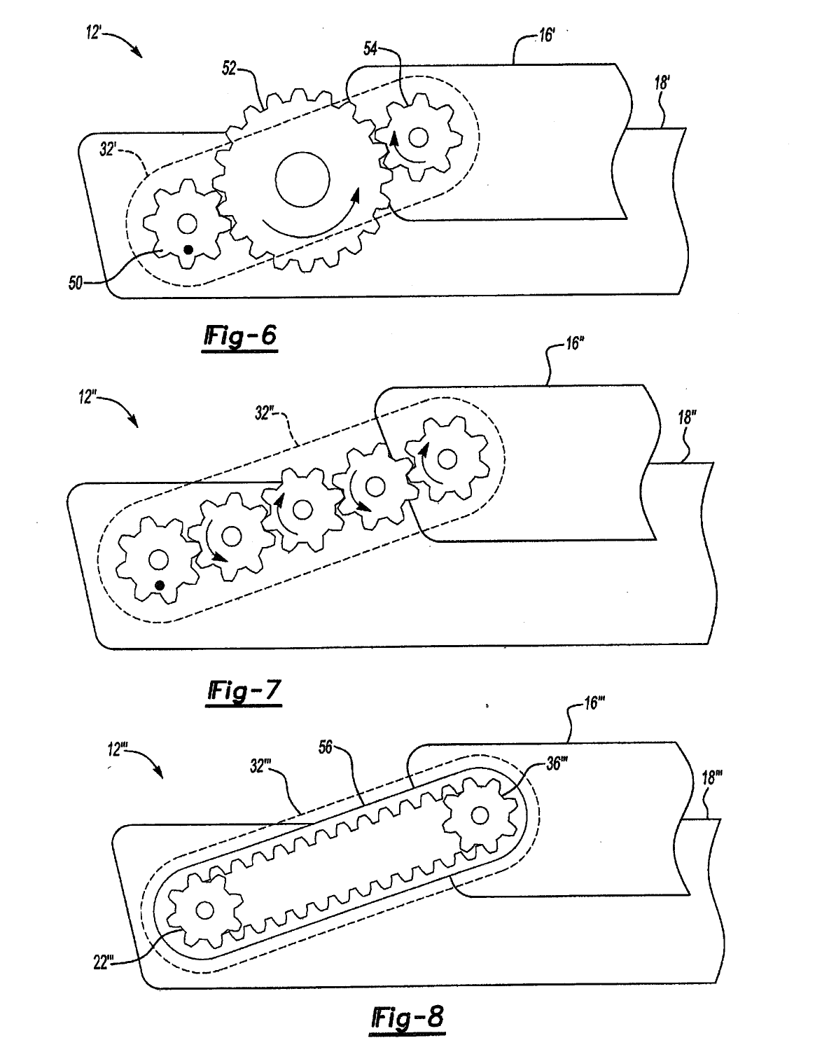

Additional embodiments of height adjustable armrest assembly 12 are illustrated in FIGS. 6-8. Parts or components of these additional embodiments that are similar or identical in function to corresponding parts of the first embodiment of the height adjustable armrest assembly 12 illustrated in FIGS. 1-5 are given the same reference numeral with a prime notation. A second embodiment illustrated in FIG. 6 is a 3-gear linkage consisting of a first gear 50, a second gear 52, and a third gear 54 mounted on first bar 32′. First gear 50 is mounted such that it does not rotate with respect to support member 18′ as armrest member 16′ is raised and lowered. Second gear 52 and third gear 54 are configured to rotate with respect to first gear 50 as armrest member 16′ is raised and lowered, and armrest member 16′ rotates together with third gear 54. In this configuration, when armrest member 16′ is raised, the teeth of second gear 52 engage the teeth of first gear 50 causing second gear 52 to rotate in a counterclockwise direction (with respect to FIG. 6). The counterclockwise rotation of second gear 52 causes third gear 54 to rotate in a clockwise direction with respect to second gear 52 (when viewed from the perspective of FIG. 6). The rotation of third gear 54 with respect to second gear 52 allows armrest member 16′ to maintain a substantially constant angular orientation with respect to support member 18′ as armrest member 16′ is raised. Use of the second embodiment in conjunction with height adjustable armrest assembly 12′ permits construction of a height adjustable armrest assembly having only one link between the armrest member 16′ and the support member 18′. An additional 3-gear linkage may also be used to connect armrest member 16′ to support member 18′ at a location spaced apart from 3-gear linkage 48, if desired. When armrest member 16′ is lowered, the second and third gears 52,54 rotate clockwise and counter-clockwise, respectively and maintain the angular orientation of armrest member 16′ with respect to support member 18′.

FIG. 7 illustrates a third embodiment of linkage 20 joining armrest member 16″ to support member 18″. In this third embodiment, a 5-gear linkage connects armrest member 16″ to support member 18″ and works in substantially the same fashion as described above with respect to the second embodiment. In both FIGS. 6 and 7, each individual gear has been illustrated as having teeth disposed along its entire perimeter. In other embodiments, such teeth need not completely encircle each gear. Rather, it would be sufficient to have teeth disposed at only those arcs along a perimeter of each gear where that gear engages its adjacent gear and need only extend far enough to accommodate the intended range of rotation of that gear as the armrest member is raised and lowered.

A third embodiment of the height adjustable armrest assembly 12 is illustrated in FIG. 8. In the third embodiment, first pivotal connector 22′″ and third pivotal connector 36′″ include teeth and are connected to one another by a looped belt 56 having teeth that engage the teeth of first pivotal connector 22′″ and third pivotal connector 36′″. As with the second and third embodiments discussed above, this fourth embodiment permits armrest member 16′″ to be raised and lowered with respect to support member 18′″ while maintaining a substantially constant angular orientation. Use of this fourth embodiment negates the need for a second arrangement of pivotal connectors and looped belt at a location spaced apart along armrest member 16′″ and support member 18′″.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A height adjustable armrest assembly for use with a vehicle, the assembly comprising:
a support member adapted for connection to a vehicle body;
a linkage supported by the support member; and
an armrest member supported by the linkage,
wherein the linkage is configured to move the armrest member between a lowered position and a raised position such that the angular orientation between the support member and the armrest member when the armrest member is in the raised position is substantially the same as when the armrest member is in the lowered position.

2. The assembly of claim 1 wherein the linkage comprises a plurality of bars.

3. The assembly of claim 2 wherein each bar is substantially parallel to each of the other bars and wherein each bar remains substantially parallel to each of the other bars as the armrest member moves between the raised position and the lowered position.

4. The assembly of claim 2 wherein the support member, the armrest member and the plurality of bars define a four bar mechanism.

5. The assembly of claim 1 wherein the linkage includes a lockable hinge that is configured to inhibit movement of the armrest member from the raised position towards the lowered position when the hinge is locked and to permit movement of the armrest member from the raised position towards the lowered position when the hinge is unlocked.

6. The assembly of claim 5 wherein the lockable hinge comprises a wrap spring clutch.

7. The assembly of claim 5 wherein the linkage further comprises a second lockable hinge configured to inhibit movement of the armrest member from the raised position towards the lowered position when the second lockable hinge is locked and to permit movement of the armrest member from the raised position towards the lowered position when the second lockable hinge is unlocked.

8. The assembly of claim 5 wherein the linkage is configured to maintain a substantially constant angular orientation of the armrest member as the armrest member moves between the lowered position and the raised position and wherein the lockable hinge and the linkage cooperate to support the armrest member at a plurality of user selected height positions disposed between the raised position and the lowered position.

9. The assembly of claim 1 further comprising a motion damper connected to the linkage and configured to slow the movement of the armrest member from the raised position towards the lowered position.

10. A height adjustable armrest assembly for use with a vehicle, the assembly comprising:
a support member adapted for connection to a vehicle body;
a first bar pivotably connected to the support member;
a second bar pivotably connected to the support member at a position spaced apart from the first bar;
an armrest member supported by the first bar and the second bar;
wherein the first bar and the second bar cooperate to maintain a substantially constant angular orientation of the armrest member with respect to the support member as the armrest member is raised and lowered.

11. The assembly of claim 10 further comprising a lockable hinge connecting one of the first and the second bars to one of the armrest member and the support member, the lockable hinge being configured to inhibit pivoting in a first direction when locked and to permit pivoting in the first direction when released.

12. The assembly of claim 11 further comprising a release member for selectively unlocking the hinge member.

13. The height adjustable armrest assembly of claim 11 wherein the armrest member is wider than the hinge when measured in a direction perpendicular to a longitudinal axis of the armrest member.

14. The height adjustable armrest assembly of claim 11 wherein the lockable hinge is a first hinge, the assembly further comprising a second lockable hinge connecting the other of the first and the second bars to one of the armrest member and the support member, the second lockable hinge being configured to inhibit pivoting in the first direction when locked and to permit pivoting in the first direction when released.

15. The height adjustable armrest assembly of claim 11 wherein the lockable hinge is a wrap spring clutch.

16. The height adjustable armrest assembly of claim 10 further comprising a motion damper connected to one of the first bar and the second bar to slow the armrest member as the armrest member moves from the raise position towards the lowered position.

17. A height adjustable armrest assembly for use with a vehicle, the assembly comprising:
a support member adapted for connection to a vehicle body;
a bin disposed below the support member;
a linkage supported by the support member; and
an armrest member supported by the linkage and configured to selectively cover and uncover the bin,
wherein the linkage is configured to move the armrest member between a lowered position and a raised position such that the angular orientation between the support member and the armrest member when the armrest member is in the raised position is substantially the same as when the armrest member is in the lowered position.

18. The assembly of claim 17 wherein the linkage comprises a plurality of bars, each bar being substantially parallel to each of the other bars and each bar remaining substantially parallel to each of the other bars as the armrest member moves between the raised position and the lowered position.

19. The assembly of claim 18 wherein the linkage includes a lockable hinge that is configured to inhibit movement of the armrest member from the raised position towards the lowered position when locked and to permit movement of the armrest member from the raised position towards the lowered position when unlocked.

20. The assembly of claim 19 further comprising a motion damper connected to the linkage and configured to slow the movement of the armrest member from the raised position towards the lowered position.
